(19) United States
(12) Patent Application Publication
(10) Pub. No.: US 2015/0073088 A1
(43) Pub. Date: Mar. 12, 2015

(54) COMPOSITE OF FILLER AND POLYMER RESIN AND METHOD FOR PREPARING THE SAME

(71) Applicant: KOREA INSTITUTE OF SCIENCE AND TECHNOLOGY, Seoul (KR)

(72) Inventors: Seong Yun KIM, Seoul (KR); Cheol-Min YANG, Suwon-si (KR); Yong Chae JUNG, Wanju-gun (KR); Junyeon HWANG, Jeonju-si (KR); Yeji NOH, Hongseong-gun (KR); Hun-su LEE, Seoul (KR); Munju GOH, Wanju-gun (KR)

(73) Assignee: KOREA INSTITUTE OF SCIENCE AND TECHNOLOGY, Seoul (KR)

(21) Appl. No.: 14/067,464

(22) Filed: Oct. 30, 2013

(30) Foreign Application Priority Data
Sep. 6, 2013 (KR) 10-2013-0107439

(51) Int. Cl. C08J 3/20

(52) U.S. Cl. CPC C08J 3/20; C08J 2367/02
USPC 524/605

(57) ABSTRACT

Disclosed is a composite of filler and polymer resin and a method for preparing the same, including preparing a thermoplastic resin composition by mixing a polymerization catalyst with a polymerizable thermoplastic resin, preparing a pre-pellet including a filler and a polymer resin by mixing a filler with the thermoplastic resin composition and heating to perform in-situ polymerization of the polymerizable thermoplastic resin to the polymer resin, and compounding the pre-pellet or the pre-pellet to which a polymer resin is further added to be pelletized.

### CROSS-REFERENCE TO RELATED APPLICATION

This application claims priority to Korean Patent Application No. 10-2013-0107439, filed on Sep. 6, 2013, and all the benefits accruing therefrom under 35 U.S.C. §119, the contents of which in its entirety are herein incorporated by reference.

### BACKGROUND

1. Field

The present disclosure relates to a composite of filler and polymer resin and a method for preparing the same.

2. Description of the Related Art

After carbon nanotube was first discovered by Ijima, studies have been conducted on polymer resin composites which utilize superior physical properties of the carbon nanotubes. Although various composites exhibiting good physical properties of carbon nanotube were developed and reported in laboratory scale, large scale production and distribution of the composites have not yet met the expectation.

Specifically, the dispersion characteristics of carbon nanotubes which tend to aggregate due to van der Waals' interaction are controlled relatively well by chemical and physical methods in laboratory scale. However, as the scale becomes large, the process cost also increases sharply and further the dispersion of carbon nanotube is not controlled well due to various limitations such as time, etc. As a result, non-uniform and incomplete contact between the carbon nanotubes often occurs.

Since it is not easy to control the dispersion characteristics of carbon nanotubes especially when polymer resin composites including carbon nanotubes are produced in large scale, such useful physical properties of the carbon nanotube are not able to be fully expressed in the composite. Accordingly, it is difficult to obtain expected excellent thermal and other properties of the composite.

Meanwhile, in 2004, Andre Geim and his colleagues at the University of Manchester isolated single-layered graphene, which had been known to be thermodynamically unstable and unable to exist at room temperature. Since then, interests in graphene have grown.

Compared with other existing carbon materials, graphene has wider surface area, is very superior in mechanical strength and thermal/electrical properties, and has flexibility and transparency. Due to these superior mechanical, electrical and thermal properties, etc. of graphene, a polymer composite including graphene may have remarkably improved physical properties. In addition, since graphene exhibits superior gas barrier property owing to its structural features, polymer composites including graphene have been drawing attractions in various applications, including electronic devices, energy storage media, organic solar cells, heat-insulating materials, film packaging materials, biomimetic devices, or the like.

However, when preparing a polymer composite including graphene, particularly nanographene, it is difficult to achieve uniform dispersion of graphene in the polymer resin because of, for example, rapid increase in viscosity of the polymer resin during mixing. Accordingly, achieving the superior physical properties expected for the composite was actually difficult.

In particular, if graphene is not uniformly dispersed in the polymer resin and fails to bond at the interface with the resin, the graphene becomes aggregated. To this end, the physical properties of the composite become rather worse due to cracks, pores and pinholes, etc.

The conventional method for preparing a polymer resin composite by compounding fillers such as micro or nano sized fine fillers, for example, metal filler, ceramic filler or carbon filler, in particular, nanocarbon such as carbon nanotube or nano graphene, etc. with a polymer resin has limitation in increasing the content of the fillers while dispersing the fillers. As a result, the content of the fillers in such composite has not reached to about 30 wt %.

Further, even a polymer resin composite where the filler content is about 20-30 wt %, which is relatively at a highest level in the conventional polymer resin composites, exhibits unsatisfactory physical properties resulting from the poor dispersing including aggregation etc. and non-uniform and incomplete contact between the fillers as well as the low filler content.

### SUMMARY

The present disclosure is directed to providing a method for preparing a composite of filler, for example, metal filler, ceramic filler or carbon filler, in particular, nanocarbon such as carbon nanotube or nano graphene, etc. and polymer resin. According to the method, the filler may be included in the composite at a high content of about 30 wt % or more. Further, according to the method, it is possible to reduce the problems of poor dispersion and non-uniform and incomplete contact between the fillers that may occur during a preparation (particularly, during large scale preparation) of the composite having the high content of the filler.

The present disclosure is also directed to providing a composite of filler, for example, metal filler, ceramic filler or carbon filler, in particular, nanocarbon such as carbon nanotube or nano graphene, etc. and polymer resin. The filler may be included in the composite at a high content of about 30 wt % or more and the composite may have improved physical properties.

In some embodiments, there is provided a method for preparing a composite of filler and polymer resin, including: preparing a thermoplastic resin composition by mixing a polymerization catalyst with a polymerizable thermoplastic resin; preparing a pre-pellet including a filler and a polymer resin by mixing a filler with the thermoplastic resin composition and heating to perform in-situ polymerization of the polymerizable thermoplastic resin to the polymer resin; and compounding the pre-pellet or the pre-pellet to which a polymer resin is further added to be pelletized.

Specifically, in an example embodiment, the thermoplastic resin composition in a powder form and the filler in a powder form may be mixed and heated to be in-situ polymerized.

In an example embodiment, the polymer resin further added to the pre-pellet may be a polymer resin miscible with the polymer resin included in the pre-pellet.

In an example embodiment, the polymer resin further added to the pre-pellet may be the same polymer resin as the polymer resin included in the pre-pellet.

In an example embodiment, the filler may be included in an amount of about 30-95 wt % based on the total weight of the pelletized composite.

In an example embodiment, when preparing the pre-pellet, the polymerizable thermoplastic resin is heated to be melted and impregnated between the fillers, and further heated to a polymerization temperature or higher and below a thermal decomposition temperature of the thermoplastic resin.

In an example embodiment, hot pressing may be further performed by applying pressure during the heating.

In an example embodiment, the polymerizable thermoplastic resin may be a cyclic butylene terephthalate (CBT), caprolactam or oligomer resin.

In an example embodiment, the polymerization catalyst may be titanium tetroxide (TiO₄).

In an example embodiment, the polymerizable thermoplastic resin may be a CBT resin, a mixture of the filler and the thermoplastic resin composition may be put in a mold and then in-situ polymerization may be performed in the mold, the mold may be heated to about 150-260° C. in about 0-30 second (more than about 0 seconds and about 30 seconds or less), the heating temperature may be maintained for about 1 minute to about 24 hours, and the mold may be cooled to room temperature in about 0-60 seconds (more than about 0 seconds and about 60 seconds or less).

In an example embodiment, the filler may be at least one selected from the group consisting of metal filler, ceramic filler and carbon filler.

In an example embodiment, the filler may be metal filler.

In an example embodiment, the filler may be ceramic filler.

In an example embodiment, the filler may be carbon filler.

In an example embodiment, the filler may be nanocarbon.

In an example embodiment, the filler may be one or more selected from a nanocarbon group consisting of carbon nanotube (CNT), nanographene and nanographene oxide, or one or more selected from the said nanocarbon group treated with heat, hydrogen peroxide or aqua regia.

In an example embodiment, the composite of filler and polymer resin may have a thermal conductivity of about 25 W/m·K or higher.

In some other embodiments, there is provided a composite of filler and polymer resin, comprising a filler and a polymer resin, wherein the filler is included in an amount of about 30-95 wt % based on the total weight of the composite, a polymerizable thermoplastic resin is polymerized to be the polymer resin, and a melt viscosity of the thermoplastic resin decreases when polymerized.

In an example embodiment, the filler may be at least one selected from the group consisting of metal filler, ceramic filler and carbon filler.

In an example embodiment, the filler may be metal filler.

In an example embodiment, the filler may be ceramic filler.

In an example embodiment, the filler may be carbon filler.

In an example embodiment, the filler may be nanocarbon.

In an example embodiment, the composite of filler and polymer resin may have a thermal conductivity of about 25 W/m·K or higher.

The composite of filler and polymer resin according to the embodiments of the present disclosure may include a filler with a high content of at least about 30 wt % even when the composite is prepared in large scale. Further, even at the high content of the filler, it is easy to disperse the filler uniformly and the contact between the fillers may be improved.

In addition, the composite of filler and polymer resin according to the embodiments of the present disclosure may have improved physical properties such as mechanical, thermal, electrical properties, etc.

### BRIEF DESCRIPTION OF THE DRAWINGS

The above and other aspects, features and advantages of the disclosed example embodiments will be more apparent from the following detailed description taken in conjunction with the accompanying drawings in which:

FIG. 1 schematically shows a process of preparing a composite of filler (e.g. nanocarbon) and polymer resin according to an example embodiment of the present disclosure;

FIG. 2 shows photographs of mixture powders before preparation of pre-pellets (top) and polymerized pre-pellets (bottom) according to example embodiments of the present disclosure; and

FIG. 3 shows a result of measuring a thermal conductivity of finally prepared composites of nanocarbon and polymer resin depending on the nanocarbon content in the examples of the present disclosure.

### DETAILED DESCRIPTION

Example embodiments now will be described more fully hereinafter with reference to the accompanying drawings, in which example embodiments are shown. The present disclosure may, however, be embodied in many different forms and should not be construed as limited to the example embodiments set forth therein. Rather, these example embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Furthermore, the use of the terms a, an, etc. do not denote a limitation of quantity, but rather denote the presence of at least one of the referenced item. The terms “first,” “second,” and the like do not imply any particular order, but are included to identify individual elements. Moreover, the use of the terms first, second, etc. do not denote any order or importance, but rather the terms first, second, etc. are used to distinguished one element from another.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

As used in the present disclosure, the term polymerizable thermoplastic resin refers to a thermoplastic resin whose viscosity decreases when heated and melted, and is polymerized into a polymer resin if further heated.

As used in the present disclosure, the term in-situ polymerization refers to polymerization where a polymerizable thermoplastic resin is melted and polymerized into a polymer resin by heating.

As used in the present disclosure, the term compounding, as well known in the art, refers to melting, mixing and molding (e.g. extrusion molding) in melt state of a material including a polymer resin, etc.

As used in the present disclosure, the term pre-pellet refers to a composite obtained from polymerization of a mixture of a filler and a thermoplastic resin composition, before pelletizing.

As used in the present disclosure, the term metal filler refers to a filler made of metal.

As used in the present disclosure, the term ceramic filler refers to a filler made of ceramic.

As used in the present disclosure, the term carbon filler refers to a filler made of carbon-based material (for example, graphite, carbon fiber, etc.)

As used in the present disclosure, the term nanocarbon refers to a carbon-based material which with a nano-scale size (1000 nm or smaller) that can form bonding in molecular level (for example, carbonanotube, nano graphene, etc.)

In the embodiments of the present disclosure, a polymerization catalyst and a polymerizable thermoplastic resin are first mixed and dispersed to prepare a composition (specifically, a composition in a powder form), and the composition is mixed with a filler (specifically, a filler in a powder form) and dispersed and in-situ polymerized to prepare a pre-pellet, which is then pelletized by compounding.

By such method, a filler content in a composite of filler and polymer resin may be increased to at least 30 wt % when the composite is prepared (especially in large scale). In addition, the problems of dispersion such as agglormeration and non-uniform and incomplete contact between the fillers, etc. may be reduced even at such high content of the fillers, and it is possible to obtain a composite of filler and polymer resin having remarkably improved physical properties such as mechanical, thermal and electrical properties, etc., particularly the thermal properties.

A method for preparing a composite of filler and polymer resin according to the embodiments of the present disclosure includes preparing a thermoplastic resin composition by mixing a polymerization catalyst with a polymerizable thermoplastic resin, preparing a pre-pellet including a filler and a polymer resin by mixing a filler with the thermoplastic resin composition and heating to perform in-situ polymerization of the polymerizable thermoplastic resin to the polymer resin, and melting, mixing and molding in melt state (i.e., compounding) the pre-pellet or the pre-pellet, to which a polymer resin is further added, to be pelletized.

Hereinafter, the method will be described in more detail. Although the embodiments using nanocarbon are mainly explained below since it is especially difficult to induce high content and high level of dispersion of nanocarbon, it will be understood that the embodiments of the present disclosure are not limited to nanocarbon, but rather applicable to all other fillers, for example, micro sized fillers as well as nano sized fillers and other kinds of fillers (e.g. metal filler, ceramic filler) as well as carbon based fillers. Further, a combination of two or more of the fillers may be used.

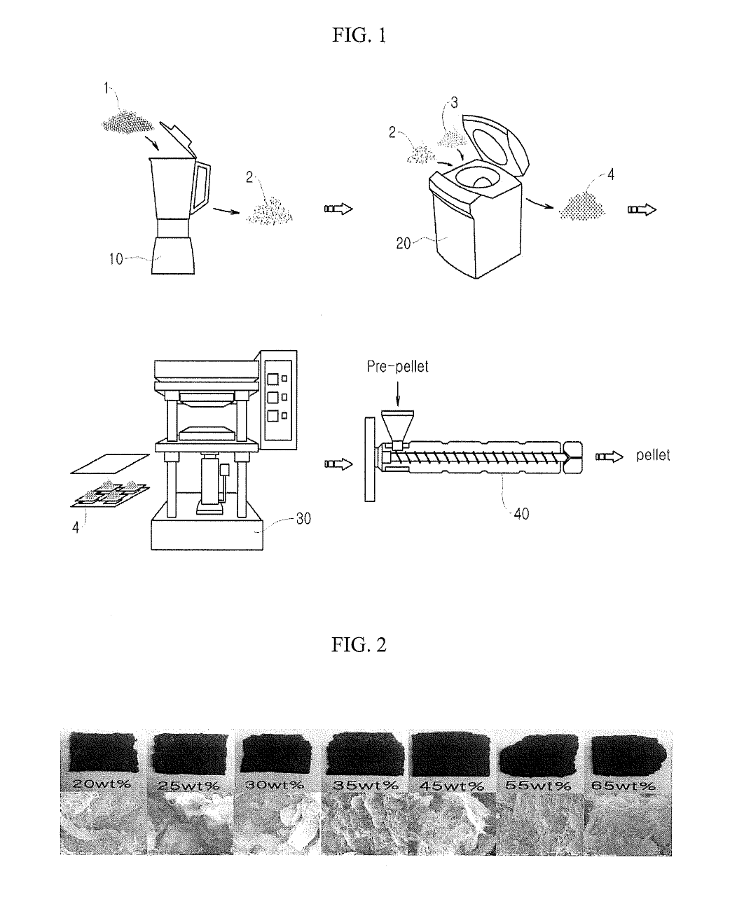

FIG. 1 schematically shows a process of preparing a composite of filler (e.g. nanocarbon) and polymer resin according to an example embodiment of the present disclosure.

Referring to FIG. 1, in an example embodiment of the present disclosure, a polymerizable thermoplastic resin and a polymerization catalyst 1 (The thermoplastic resin and the polymerization catalyst are denoted by 1 in FIG. 1) are first dispersion-mixed using, for example, a mixer 10 to prepare a thermoplastic resin composition 2.

The polymerizable thermoplastic resin may have a low melt viscosity so that it can easily penetrate and be impregnated into the nanocarbon during the following preparation of a pre-pellet.

That is, the polymerizable thermoplastic resin may have a low melt viscosity of tens to hundreds of cps. For example, a cyclic butylene terephthalate (CBT) or caprolactam may be used. Oigomer type resin may also be used. The CBT resin may become a polybutylene terephthalate (PBT) resin after polymerization, the caprolactam resin may become a polyamide resin (nylon resin) after polymerization. The oligomer resin may become a polymer resin after polymerization. Particularly, the PBT or polyamide resin is suitable for a composite owing to superior heat resistance and mechanical strength.

Although the thermoplastic resin may be in a powder or pellet form, the thermoplastic resin may be specifically in a powder form in that it is preferable to disperse the filler (specifically, nanocarbon) at high content by powder-mixing and in-situ polymerization when preparing the pre-pellet.

The polymerization catalyst is mixed with the polymerizable thermoplastic resin and constitutes the thermoplastic resin composition. It is used to induce and facilitate the polymerization of the thermoplastic resin.

In an example embodiment, titanate, stannoxane, etc. may be used as the polymerization catalyst. Particularly, titanium tetroxide (TiO₄) may be used.

The polymerization catalyst may be included in the thermoplastic resin composition in an amount of, for example, about 0.02-1 mol %, more specifically, for example, about 0.5 mol %.

The prepared thermoplastic resin composition 2 is mixed with a nanocarbon 3 using, for example, a Thinky mixer 20.

The viscosity of a polymerizable thermoplastic resin in the mixture of nanocarbon 3 with the thermoplastic resin composition 2 decreases remarkably during melting and allows impregnation between the nanocarbon and thus allows uniform dispersion, and then the polymerizable thermoplastic resin is in situ polymerized to prepare a pre-pellet. As a result, superior dispersion may be achieved even when the nanocarbon is included in an amount of 30 wt % or higher in the composite, and the physical properties of the composite may be improved since the dispersion problems such as non-uniform and incomplete contact between the nanocarbon may be prevented.

In an example embodiment, the filler may be, but is not limited to, at least one selected from the group consisting of metal filler, ceramic filler and carbon filler, and may be carbon filler. The carbon filler may be micro-sized or nanocarbon.

In an example embodiment, the nanocarbon may be one or more selected from a nanocarbon group consisting of carbon nanotube (CNT), nanographene and nanographene oxide. Further, the nanocarbon may be a nanocarbon such as carbon nanotube, graphene, graphene oxide, etc. treated with heat, hydrogen peroxide, aqua regia, etc.

In an example embodiment, the nanocarbon may be specifically in a powder form for uniform dispersion of the nanocarbon in the final composite.

A method for mixing the thermoplastic resin composition and the nanocarbon is not particularly limited as long as the thermoplastic resin composition and the nanocarbon can be mixed uniformly.

In an example embodiment, the mixing may be performed using a Thinky mixer, a ball mill, etc.

After the mixing, in-situ polymerization is performed. That is, a mixture 4 of the thermoplastic resin composition 2 and the nanocarbon 3 is supplied to a polymerization reactor 30 and a pre-pellet including a nanocarbon and a polymer resin is prepared by in-situ polymerization. As described above, the thermoplastic resin uniformly penetrates and is impregnated between the nanocarbon during the in-situ polymerization process, and a pre-pellet composite of nanocarbon and polymer resin wherein the nanocarbon is uniformly dispersed may be prepared.

The polymerization of the polymerizable thermoplastic resin occurs quickly at high temperatures and slowly at low temperatures. Accordingly, heating is performed to a polymerization starting temperature or higher and below a thermal decomposition temperature of the thermoplastic resin. Specifically, the polymerizable thermoplastic resin may be heated to the polymerization starting temperature in a short time, maintained at the polymerization starting temperature or higher and below the thermal decomposition temperature of the thermoplastic resin for a predetermined time, and then cooled rapidly.

For example, the CBT resin is melted around 130° C. and polymerization begins at about 150° C. or higher. Although the polymerization occurs faster at higher temperatures, thermal decomposition may occur above about 260° C. Accordingly, the CBT resin is heated to the corresponding temperature range (e.g., about 150-260° C.) in a short time (e.g., in about 0-30 seconds), maintained at the temperature for a predetermined time (e.g., for about 1 minute to about 24 hours, it is preferable to reduce this time as much as possible), and then cooled to rapidly (e.g., in about 0-60 seconds).

In an example embodiment, the heating and cooling for the in-situ polymerization may be performed by controlling the temperature of a mold. That is, after a mixture is prepared by mixing the thermoplastic resin composition and the nanocarbon, it is put in a mold. The mold is heated to about 150-260° C. in about 0-30 seconds, the heating temperature (about 150-260° C.) is maintained for about 1 minute to about 24 hours, and the mold is cooled to a room temperature in about 0-60 seconds. The rate of heating or cooling may be, for example, about 40-50° C./sec.

Specifically, in an example embodiment, the mold may be heated to about 250-260° C., and the heating temperature may be maintained for about 1-2 minutes.

By heating the mold rapidly, maintaining the temperature for a time and cooling in a short time, a polymer composite of a nanocarbon and a polymer resin may be prepared in a short time in large scale. Also, because only the mold is cooled rapidly, the factors that may negatively affect the physical properties of the product may be avoided and a composite having uniform physical properties may be prepared.

In an example embodiment, hot pressing may be further performed by applying pressure as well as heat when preparing the pre-pellet. The hot pressing may be performed in a hot pressing mold.

As described above, the nanocarbon (filler) may be uniformly dispersed in the prepared pre-pellet even when the content of the nanocarbon is high (e.g., 30 wt % or higher). In particular, if the nanocarbon in a powder form and the thermoplastic resin composition in a powder form (the composition having the polymerization catalyst and the polymerizable thermoplastic resin) are mixed and the mixture is in-situ polymerized, the nanocarbon may be very uniformly dispersed in the pre-pellet even when the content of the nanocarbon is high. Accordingly, the finally prepared composite (i.e. pellet) of f nanocarbon and polymer resin may have improved physical properties, particularly in terms of thermal conductivity.

Next, a pre-pellet composite of a filler (e.g. nanocarbon) and a polymer resin is pelletized by compounding (see FIG. 1).

In the pre-pellet composite, the filler may be well dispersed even at high content. However, a large number of pores may be present in the pre-pellet composite and complete processing may be difficult. Also, because of the high content of the filler, the rigidity of the composite may increase and, as a result, mechanical properties such as impact resistance and tensile property may be unsatisfactory. To solve this problem, the pre-pellet composite is pelletized by compounding to reduce a pore generation, prevent a degradation of mechanical properties and ensure a good processability.

In an example embodiment, the pelletizing begins with an addition of the pre-pellet or the pre-pellet, to which a polymer resin is further added, to a hopper of a compounder (40). Specifically, the further added polymer resin may be a resin miscible with the thermoplastic resin used for making the pre-pellet, i.e., the polymer resin included in the pre-pellet.

For example, if a CBT resin is used as the thermoplastic resin, a PBT resin may be used as the further added polymer resin. And, if a caprolactam resin is used as the thermoplastic resin, a nylon resin may be used as the further added polymer resin. Of course, other resins may be used without considering miscibility, although it is not preferable.

The compounding may be performed under compounding conditions generally used in the art but the temperature may be controlled if necessary.

The filler (e.g. nanocarbon) may be included in an amount of about 5-95 wt % based on the total weight of the finally prepared composite. However, specifically, it is possible that the filler is included in the composite in a high content of about 30 wt % or higher, about 35 wt % or higher, about 40 wt % or higher, about 50 wt % or higher, or about 60 wt % or higher. As the content of the filler in the composite according to the embodiments is higher, the composite has more improved physical properties including thermal conductivity. However, if the content of the filler exceeds 95 wt %, the composite may not be prepared uniformly.

As described above, in the composite according to the embodiments, the filler (e.g. nanocarbon) may be dispersed uniformly even when the content of the filler is high in the composite, and the problem of non-uniform and incomplete contact between the fillers may be solved. Accordingly, various physical properties, especially thermal conductivity, may be improved.

Since the filler can be uniformly dispersed in the polymer resin composite even when the content of the filler is high, the finally prepared composite may have remarkably improved physical properties. In particular, thermal properties are greatly improved. For example, the prepared composite may exhibit an excellent thermal conductivity (about 15 W/m·K or higher, specifically about 20 W/m·K or higher, more specifically about 25 W/m·K or higher).

For reference, the conventional polymer resin-based composite may hardly exhibit a thermal conductivity of about 15 W/m·K or higher, specifically about 20 W/m·K or higher. However, the composite of filler and polymer resin according to the embodiments of the present disclosure may exhibit an excellent thermal conductivity (about 15 W/m·K or higher, specifically about 20 W/m·K or higher, more specifically about 25 W/m·K or higher).

The composite of filler and polymer resin prepared according to the embodiments of the present disclosure may be usefully used as a heat-dissipating material. For example, the composite may be useful for heat dissipation field such as LED heat-dissipating structures, notebook computers, mobile phone cases, heat sinks, etc.

### EXAMPLE

Hereinafter, the present disclosure will be described in detail through an example. However, the following example is for illustrative purposes only and it will be apparent to those of ordinary skill in the art that the scope of the present disclosure is not limited by the example.

### Example

(1) Preparation of Thermoplastic Resin Composition

Multi-walled carbon nanotube (available form Hanwha Nanotech) is prepared without special pre-treatment. And, about 0.6 g (per sample) of CBT (available from Cyclics) as a polymerizable thermoplastic resin is dispersion-mixed with titanium tetroxide (TiO₄) as a polymerization catalyst. The titanium tetroxide is included in about 0.5 mol % of the thermoplastic resin composition.

(2) Preparation of Pre-Pellet

After uniformly mixing the thermoplastic resin composition with the nanocarbon, followed by heating to about 250° C., polymerization (in-situ polymerization) is performed by hot pressing at about 20 MPa for about 2 minutes.

The thickness of the prepared pre-pellet including nanocarbon and polymer resin is about 2 mm. As the CBT included in the thermoplastic resin composition is melted, it is impregnated into the nanocarbon material and then polymerized into PBT.

FIG. 2 shows photographs of mixture powders before the preparation of the pre-pellet (top) and the polymerized pre-pellets (bottom) according to example embodiments of the present disclosure. As seen from FIG. 2, the nanocarbon content in the mixtures of the nanocarbon and the thermoplastic resin composition is about 20 wt %, about 25 wt %, about 30 wt %, about 35 wt %, about 45 wt %, about 55 wt % and about 65 wt %, respectively.

(3) Pelletizing

To the pre-pellet including about 65 wt % of the carbon nanotube among the prepared pre-pellets, a polymer resin is further added in various compositions and pelletizing is performed by compounding.

Specifically, compounding is performed after supplying a PBT resin (available from LG Chem) together with the pre-pellet in a hopper of an extruder of compounding machine. As for the compounding machine, a twin compounder (TEK20; SM Platek, Korea) is used and the processing condition is as follows. The temperatures in the compounder parts from the barrel to the nozzle are about 260° C., about 250° C., about 250° C., about 250° C., about 240° C., about 200° C. and about 180° C. respectively, and the screw speed and the supply speed are about 300 and about 24 rpm, respectively.

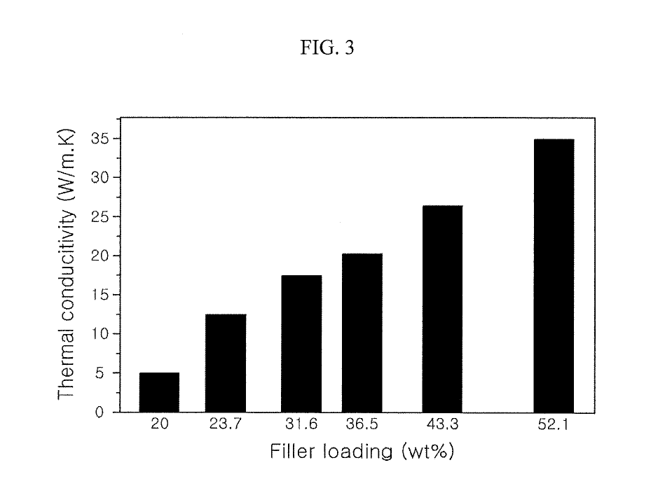

The filler (herein, carbon nanotube) content in the finally prepared composite (i.e. pellet) is about 20 wt %, about 23.7 wt %, about 31.6 wt %, about 36.5 wt %, about 43.3 wt % and about 52.1 wt %, respectively (see FIG. 3).

In order to measure the thermal conductivity of the finally prepared composite (i.e., pellet), a sample is prepared as follows. That is, the finally prepared composite is further hot-pressed for about 10 minutes in a mold at about 250° C. using a hot pressing machine (Daeheung Science) to prepare the sample. The thermal conductivity is measured according to the modified transient plane source method.

FIG. 3 shows the result of measuring the thermal conductivity of the finally prepared composites of a nanocarbon and a polymer resin depending on the nanocarbon content in this example.

As seen from FIG. 3, the thermal conductivity of the finally prepared composite increases in proportion to the content of the nanocarbon filler in the composite. An excellent thermal conductivity of about 35 W/m·K was obtained when the content is about 52.1 wt %.

When measured according to ASTM standards, the sample whose nanocarbon filler content is about 52.1 wt % and whose thermal conductivity is about 35 W/m·K also shows superior physical properties, with a tensile strength of about 650 Kgf/cm², an impact strength of about 5 Kgf·cm/cm and an electrical conductivity of about 100 Sm⁻¹.

While the example embodiments have been shown and described, it will be understood by those skilled in the art that various changes may be made thereto without departing from the spirit and scope of the present disclosure as defined by the appended claims.

What is claimed is:

1. A method for preparing a composite of filler and polymer resin, comprising:
preparing a thermoplastic resin composition by mixing a polymerization catalyst with a polymerizable thermoplastic resin;
preparing a pre-pellet including a filler and a polymer resin by mixing a filler with the thermoplastic resin composition and heating to perform in-situ polymerization of the polymerizable thermoplastic resin to the polymer resin; and
compounding the pre-pellet or the pre-pellet to which a polymer resin is further added to be pelletized.

2. The method according to claim 1, wherein the thermoplastic resin composition in a powder form and the filler in a powder form are mixed and heated to perform the in-situ polymerization.

3. The method according to claim 2, wherein the polymer resin further added to the pre-pellet is a polymer resin miscible with the polymer resin included in the pre-pellet.

4. The method according to claim 3, wherein the polymer resin further added to the pre-pellet is the same polymer resin as the polymer resin included in the pre-pellet.

5. The method according to claim 1, wherein the filler is included in an amount of about 30-95 wt % based on the total weight of the composite.

6. The method according to claim 1, wherein when preparing the pre-pellet, the polymerizable thermoplastic resin is heated to be melted and impregnated between the fillers, and further heated to a polymerization starting temperature or higher and below a thermal decomposition temperature of the polymerizable thermoplastic resin.

7. The method according to claim 6, wherein hot pressing is further performed by applying pressure during the heating.

8. The method according to claim 1, wherein the polymerizable thermoplastic resin is a cyclic butylene terephthalate (CBT), caprolactam or oligomer resin.

9. The method according to claim 8, wherein the polymerization catalyst is titanium tetroxide (TiO₄).

10. The method according to claim 8, wherein the polymerizable thermoplastic resin is a CBT resin, a mixture of the filler and the thermoplastic resin composition is put in a mold and then in-situ polymerization is performed in the mold, the mold is heated to about 150-260° C. in about 0-30 second, the heating temperature is maintained for about 1 minute to about 24 hours, and the mold is cooled to a room temperature in about 0-60 seconds.

11. The method according to claim 1, wherein the filler is at least one selected from the group consisting of metal filler, ceramic filler and carbon filler.

12. The method according to claim 1, wherein the filler is nanocarbon.

13. The method according to claim 12, wherein the nanocarbon is one or more selected from a nanocarbon group consisting of carbon nanotube (CNT), nanographene and nanographene oxide, or one or more selected from the nanocarbon group treated with heat, hydrogen peroxide or aqua regia.

14. The method according to claim 1, wherein the composite has a thermal conductivity of about 25 W/m·K or higher.

15. A composite of filler and polymer resin, comprising a filler and a polymer resin, wherein the filler is included in an amount of about 30-95 wt % based on the total weight of the composite, a polymerizable thermoplastic resin is polymerized to be the polymer resin, and a melt viscosity of the polymerizable thermoplastic resin decreases when polymerized.

16. The composite according to claim 15, wherein the filler is included in an amount of about 50-95 wt % based on the total weight of the composite.

17. The composite according to claim 15, wherein the filler is at least one selected from the group consisting of metal filler, ceramic filler and carbon filler.

18. The composite according to claim 15, wherein the filler is carbon filler.

19. The composite according to claim 15, wherein the filler is nanocarbon.

20. The composite according to claim 15, wherein the composite has a thermal conductivity of about 25 W/m·K or higher.
